(19) United States
(12) Patent Application Publication
(10) Pub. No.: US 2025/0350038 A1
(43) Pub. Date: Nov. 13, 2025

(54) RADIO WAVE CONTROL PLATE AND COMPOSITE RESONATOR

(71) Applicant: KYOCERA CORPORATION, Kyoto-shi, Kyoto (JP)

(72) Inventors: Hiromichi YOSHIKAWA, Yokohama-shi, Kanagawa (JP); Masamichi YONEHARA, Yokohama-shi, Kanagawa (JP)

(21) Appl. No.: 18/994,522

(22) PCT Filed: Jul. 6, 2023
(86) PCT No.: PCT/JP2023/025189

§ 371 Date: Jan. 14, 2025

(30) Foreign Application Priority Data
Jul. 26, 2022 (JP) 2022-118945
Aug. 25, 2022 (JP) 2022-134495

(51) Int. Cl. H01Q 15/00; H01P 7/08; H01Q 9/04; H01Q 15/02

(52) U.S. Cl. CPC H01Q 15/0026; H01P 7/08; H01Q 9/0407; H01Q 15/02

(57) ABSTRACT

A radio wave control plate includes a plurality of unit structures arrayed in a first plane direction and a reference conductor serving as a reference potential of the plurality of unit structures. The plurality of unit structures each include a first resonator extending in the first plane direction, and a second resonator separated from the first resonator in a first direction and extending in the first plane direction. At least one of the first resonator or the second resonator includes a first electrode extending in the first plane direction, a second electrode separated from the first electrode in the first direction and extending in the first plane direction, and a liquid crystal layer disposed between the first electrode and the second electrode and extending in the first plane direction.

### TECHNICAL FIELD

The present disclosure relates to a radio wave control plate and a composite resonator.

### BACKGROUND OF INVENTION

A known technique involves controlling electromagnetic waves without using a dielectric lens. For example, Patent Document 1 describes a technique of refracting a radio wave by changing parameters of respective elements in a structure including an array of resonator elements.

### CITATION LIST

### Patent Literature

Patent Document 1: JP 2015-231182 A

### SUMMARY

A radio wave control plate according to the present disclosure includes a plurality of unit structures arrayed in a first plane direction, and a reference conductor serving as a reference potential of the plurality of unit structures, in which each of the plurality of unit structures includes a first resonator extending in the first plane direction, and a second resonator separated from the first resonator in a first direction and extending in the first plane direction, and at least one of the first resonator or the second resonator includes a first electrode extending in the first plane direction, a second electrode separated from the first electrode in the first direction and extending in the first plane direction, and a liquid crystal layer disposed between the first electrode and the second electrode and extending in the first plane direction.

A composite resonator according to the present disclosure includes a first resonator extending in the first plane direction, and a second resonator separated from the first resonator in a first direction and extending in the first plane direction, and at least one of the first resonator or the second resonator includes a first electrode extending in the first plane direction, a second electrode separated from the first electrode in the first direction and extending in the first plane direction, and a liquid crystal layer disposed between the first electrode and the second electrode and extending in the first plane direction.

### BRIEF DESCRIPTION OF THE DRAWINGS

FIG. 1 is a diagram illustrating an overview of a radio wave refracting plate according to a first embodiment.

FIG. 2 is a diagram illustrating a configuration example of a unit structure according to the first embodiment.

FIG. 3A is a diagram illustrating a configuration example of a first resonator according to the first embodiment.

FIG. 3B is a diagram illustrating a configuration example of the first resonator according to the first embodiment.

FIG. 4A is a diagram illustrating a configuration example of a second resonator according to the first embodiment.

FIG. 4B is a diagram illustrating a configuration example of the second resonator according to the first embodiment.

FIG. 5 is a diagram illustrating a configuration example of a reference conductor according to the first embodiment.

FIG. 6A is a diagram illustrating a configuration example of a first resonator according to a variation of the first embodiment.

FIG. 6B is a diagram illustrating a configuration example of a first resonator according to the variation of the first embodiment.

FIG. 7 is a diagram illustrating a configuration example of a unit structure according to a second embodiment.

FIG. 8 is a diagram illustrating a configuration example of an arrangement example of a unit structure according to a third embodiment.

FIG. 9 is a diagram illustrating a method of applying a voltage to the unit structure according to the third embodiment.

FIG. 10 is a diagram illustrating a configuration example of a unit structure according to a fourth embodiment.

FIG. 11 is a diagram illustrating a configuration example of a unit structure according to a variation of the fourth embodiment.

FIG. 12 is a diagram illustrating an arrangement example of the unit structure according to the fourth embodiment.

FIG. 13 is a diagram illustrating a method of applying a voltage to the unit structure according to the fourth embodiment.

### DESCRIPTION OF EMBODIMENTS

In the following, embodiments of the present invention will be described in detail with reference to the accompanying drawings. The present invention is not limited by the embodiments, and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X-axis in a horizontal plane is defined as an X-axis direction, a direction parallel to a Y-axis orthogonal to the X-axis in the horizontal plane is defined as a Y-axis direction, and a direction parallel to a Z-axis orthogonal to the horizontal plane is defined as a Z-axis direction. A plane including the X-axis and the Y-axis is appropriately referred to as an XY plane, a plane including the X-axis and the Z-axis is appropriately referred to as an XZ plane, and a plane including the Y-axis and the Z-axis is appropriately referred to as a YZ plane. The XY plane is parallel to the horizontal plane. The XY plane, the XZ plane, and the YZ plane are orthogonal to each other.

### First Embodiment

### Radio Wave Refracting Plate

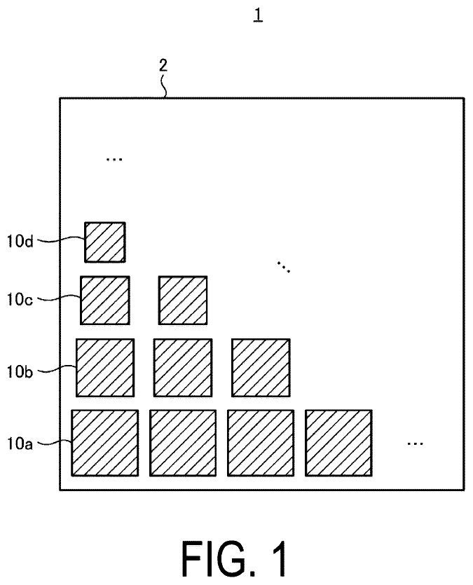

An overview of a radio wave refracting plate according to a first embodiment will be described with reference to FIG. 1. FIG. 1 is a diagram illustrating the overview of the radio wave refracting plate according to the first embodiment.

A radio wave refracting plate 1 is a plate-shaped member configured to be permeable to the radio wave transmitted from a base station. For example, the radio wave refracting plate 1 is configured to refract a radio wave at a predetermined angle and emit a refracted radio wave upon receipt of the radio wave transmitted from the base station. The radio wave refracting plate 1 may be made of, for example, a metamaterial that changes a phase of an incident wave. The radio wave refracting plate 1 is a kind of a radio wave control plate.

As illustrated in FIG. 1, the radio wave refracting plate 1 may include a substrate 2, unit structures 10a, unit structures 10b, unit structures 10c, and unit structures 10d.

The unit structures 10a, the unit structures 10b, the unit structures 10c, and the unit structures 10d may be formed on the substrate 2. The substrate 2 may have a rectangular shape, for example, but is not limited thereto. The unit structures 10a, the unit structures 10b, the unit structures 10c, and the unit structure 10d may be two dimensionally arrayed on the substrate 2.

Specifically, in the substrate 2, a plurality of unit structures 10a may be installed in a line in the bottom row of the substrate 2. On the substrate 2, a plurality of unit structures 10b may be arranged in a line above the row where the unit structures 10a are installed. On the substrate 2, a plurality of unit structures 10c may be arranged in a line above the row where the unit structures 10b are installed. On the substrate 2, a plurality of unit structures 10d may be arranged in a line above the row where the unit structures 10c are installed. That is, the radio wave refracting plate 1 may have a structure in which a plurality of unit structures having different sizes are periodically arrayed. The unit structures 10a to 10d may be different from each other in a frequency band and a change amount in a phase of the radio wave to be changed. The unit structures 10a to 10d have the rectangular shapes, without limitation. The frequency band and the change amount in a phase of the radio wave to be refracted can be adjusted by varying the sizes and shapes of the unit structure 10a, the unit structure 10b, the unit structure 10c, and the unit structure 10d.

### Unit Structure

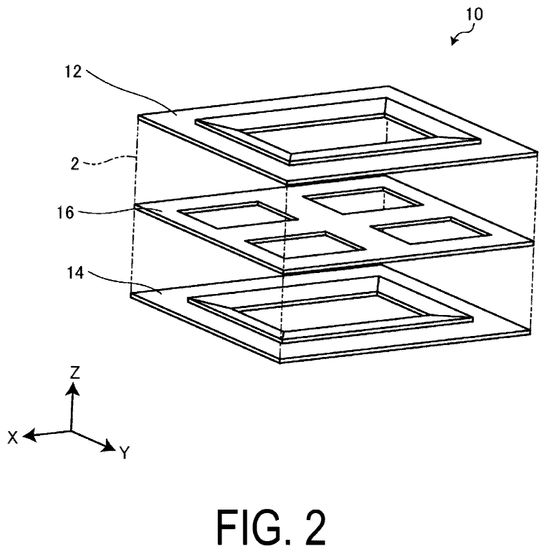

A configuration example of a unit structure according to the first embodiment will be described with reference to FIG. 2. FIG. 2 is a diagram illustrating the configuration example of the unit structure according to the first embodiment.

As illustrated in FIG. 2, a unit structure 10 includes a first resonator 12, a second resonator 14, and a reference conductor 16. The unit structure 10 may be referred to as a composite resonator.

The first resonator 12 may be arranged on the substrate 2 to extend on the XY plane. The first resonator 12 includes a conductor. The first resonator 12 may be formed, for example, in a rectangular shape. The shape of the first resonator 12 is not limited to the rectangular shape. The shape of the first resonator 12 may be optionally changed according to a design. The first resonator 12 resonates by electromagnetic waves received from the +Z-axis direction.

The first resonator 12 radiates electromagnetic waves during resonance. The first resonator 12 radiates electromagnetic waves to the-Z-axis direction side during resonance.

The second resonator 14 may be arranged on the substrate 2 to extend on the XY plane at a position away from the first resonator 12 in the Z-axis direction. The second resonator 14 may be formed, for example, in a rectangular shape. The shape of the second resonator 14 is not limited to the rectangular shape. The shape of the second resonator 14 may be optionally changed according to a design. The shape of the second resonator 14 may be the same as or different from the shape of the first resonator 12. The area of the second resonator 14 may be the same as or different from the area of the first resonator 12.

The second resonator 14 radiates electromagnetic waves during resonance. The second resonator 14 radiates electromagnetic waves to the-Z-axis direction side, for example. The second resonator 14 radiates electromagnetic waves to the-Z-axis direction side during resonance. The second resonator 14 resonates by receiving electromagnetic waves from the +Z-axis direction.

The second resonator 14 may resonate at a phase different from that of the first resonator 12. The second resonator 14 may resonate in a direction different from the resonance direction of the first resonator 12 in the XY plane direction. For example, when the first resonator 12 resonates in the X-axis direction, the second resonator 14 may resonate in the Y-axis direction. The resonance direction of the second resonator 14 may change with time in the XY plane direction corresponding to a change with time in the resonance direction of the first resonator 12. The second resonator 14 may radiate electromagnetic waves received by the first resonator 12 with a first frequency band thereof attenuated.

The reference conductor 16 may be arranged between the first resonator 12 and the

second resonator 14 in the substrate 2. The reference conductor 16 may be, for example, at the center between the first resonator 12 and the second resonator 14 in the substrate 2, but the present disclosure is not limited thereto. For example, the reference conductor 16 may be at a position where the distance from the reference conductor 16 to the first resonator 12 differs from the distance from the reference conductor 16 to the second resonator 14.

The reference conductor 16 includes at least one hole portion. The first resonator 12 and the second resonator 14 are magnetically or capacitively connected to each other via the hole portion.

In the present disclosure, at least one of the first resonator 12 or the second resonator 14 includes a liquid crystal layer. Specifically, at least one of the first resonator 12 or the second resonator 14 includes a first electrode extending on the XY plane, a second electrode separated from the first electrode in the Z-axis direction and extending on the XY plane, and a liquid crystal layer disposed between the first electrode and the second electrode and extending on the XY plane. In the present disclosure, a capacitance value of the unit structure 10 is configured to be variable by applying a voltage to the liquid crystal layer. That is, in the present disclosure, by adjusting the capacitance value of the unit structure 10, a refraction direction of the radio wave can be changed. In the example illustrated in FIG. 2, each of the first resonator 12 and the second resonator 14 includes the liquid crystal layer.

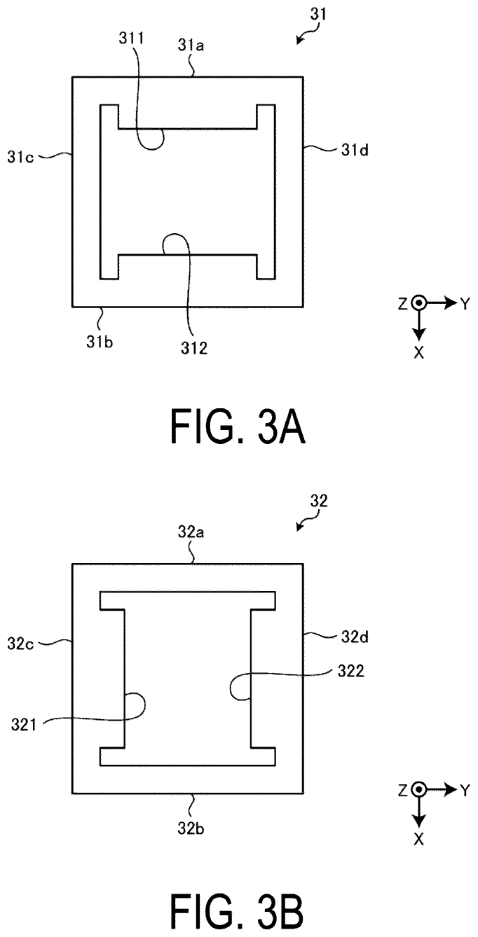

A configuration example of the first resonator according to the first embodiment will be described with reference to FIGS. 3A and 3B. FIGS. 3A and 3B are diagrams each illustrating the configuration example of the first resonator according to the first embodiment.

As illustrated in FIGS. 3A and 3B, the first resonator 12 includes a first electrode 31 and a second electrode 32. The first resonator 12 has a structure in which the first electrode 31 and the second electrode 32 overlap each other. A liquid crystal layer (not illustrated) is disposed between the first electrode 31 and the second electrode 32.

The first electrode 31 is made of a conductor. The first electrode 31 is formed in a rectangular frame shape. The first electrode 31 includes a protruding portion 311 and a protruding portion 312. That is, the first electrode 31 includes two protruding portions.

The protruding portion 311 is provided on a side portion 31a of the first electrode 31 parallel to the Y-axis. The protruding portion 311 is provided so as to protrude to an inner side in the side portion 31a. A clearance is formed between the protruding portion 311 and a side portion 31c. A clearance is formed between the protruding portion 311 and a side portion 31d. That is, the protruding portion 311 is provided so as to be magnetically or capacitively connected to the side portion 31c and the side portion 31d.

The protruding portion 312 is provided on the side portion 31b of the first electrode 31 parallel to the Y-axis. The protruding portion 312 is provided so as to protrude to an inner side in the side portion 31b. A clearance is formed between the protruding portion 312 and the side portion 31c. A clearance is formed between the protruding portion 312 and the side portion 31d. That is, the protruding portion 312 is provided so as to be magnetically or capacitively connected to the side portion 31c and the side portion 31d. That is, the first electrode 31 is configured as a λ/4 resonator.

The second electrode 32 is made of a conductor. The second electrode 32 is formed in a rectangular frame shape. The second electrode 32 includes a protruding portion 321 and a protruding portion 322. That is, the second electrode 32 includes two protruding portions.

The protruding portion 321 is provided on a side portion 32c of the second electrode 32 parallel to the X-axis. The protruding portion 321 is provided so as to protrude to an inner side in the side portion 32c. A clearance is formed between the protruding portion 321 and a side portion 32a. A clearance is formed between the protruding portion 321 and a side portion 32b. The protruding portion 321 is provided so as to be magnetically or capacitively connected to the side portion 32a and the side portion 32b.

The protruding portion 322 is provided on a side portion 32d of the second electrode 32 parallel to the X-axis. The protruding portion 322 is provided so as to protrude to an inner side in the side portion 32d. A clearance is formed between the protruding portion 322 and the side portion 32a. A clearance is formed between the protruding portion 322 and the side portion 32b. The protruding portion 322 is provided so as to be magnetically or capacitively connected to the side portion 32a and the side portion 32b. That is, the second electrode 32 is configured as a λ/4 resonator.

The first electrode 31 and the second electrode 32 have the same shape. The first electrode 31 and the second electrode 32 are disposed so as to be rotationally symmetric in the XY plane direction. Specifically, the second electrode 32 is disposed in a state of being rotated by 90 degrees in the XY plane direction with respect to the first electrode 31. The first electrode 31 and the second electrode 32 are arranged so that when viewed from one side, the other side appears to be ground. Using the above-described unit structures 10 makes it possible to configure a radio wave refracting plate for both polarized waves.

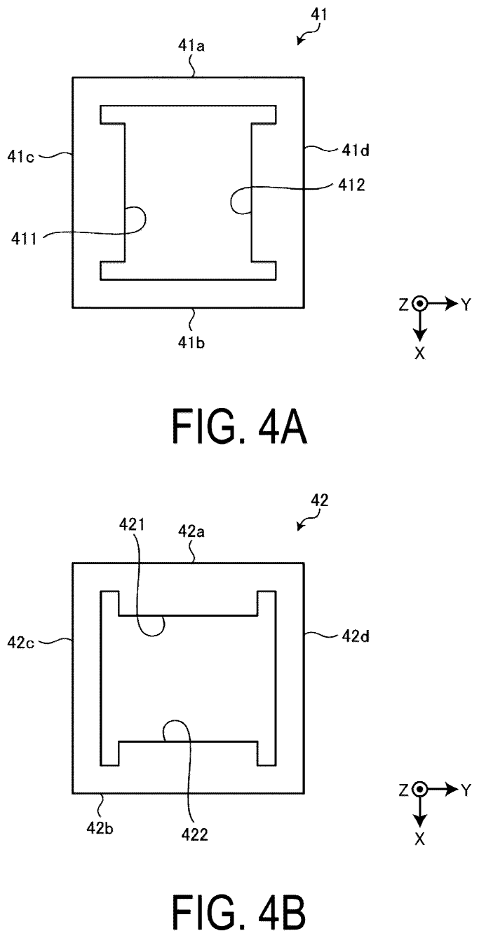

A configuration example of a second resonator according to the first embodiment will be described with reference to FIGS. 4A and 4B. FIGS. 4A and 4B are diagrams each illustrating the configuration example of the second resonator according to the first embodiment.

As illustrated in FIGS. 4A and 4B, the second resonator 14 includes a first electrode 41 and a second electrode 42. The second resonator 14 has a structure in which the first electrode 41 and the second electrode 42 overlap each other. A liquid crystal layer (not illustrated) is disposed between the first electrode 41 and the second electrode 42.

The first electrode 41 is made of a conductor. The first electrode 41 is formed in a rectangular frame shape. The first electrode 41 includes a protruding portion 411 and a protruding portion 412. That is, the first electrode 41 includes two protruding portions.

The protruding portion 411 is provided on a side portion 41c of the first electrode 41 parallel to the X-axis. The protruding portion 411 is provided so as to protrude to an inner side in the side portion 41c. A clearance is formed between the protruding portion 411 and a side portion 41a. A clearance is formed between the protruding portion 411 and a side portion 41b. The protruding portion 411 is provided so as to be magnetically or capacitively connected to the side portion 41a and the side portion 41b.

The protruding portion 412 is provided on a side portion 41d of the first electrode 41 parallel to the X-axis. The protruding portion 412 is provided so as to protrude to an inner side in the side portion 41d. A clearance is formed between the protruding portion 412 and the side portion 41a. A clearance is formed between the protruding portion 412 and the side portion 41b. The protruding portion 412 is provided so as to be magnetically or capacitively connected to the side portion 41a and the side portion 41b. That is, the first electrode 41 is configured as a λ/4 resonator.

The second electrode 42 is made of a conductor. The second electrode 42 is formed in a rectangular frame shape. The second electrode 42 includes a protruding portion 421 and a protruding portion 422. That is, the second electrode 42 includes two protruding portions.

The protruding portion 421 is provided on a side portion 42a of the second electrode 42 parallel to the Y-axis. The protruding portion 421 is provided so as to protrude to an inner side in the side portion 42a. A clearance is formed between the protruding portion 421 and a side portion 42c. A clearance is formed between the protruding portion 421 and a side portion 42d. The protruding portion 421 is provided so as to be magnetically or capacitively connected to the side portion 42c and the side portion 42d.

The protruding portion 422 is provided on a side portion 42b of the second electrode 42 parallel to the Y-axis. The protruding portion 422 is provided so as to protrude to an inner side in the side portion 42b. A clearance is formed between the protruding portion 422 and the side portion 42c. A clearance is formed between the protruding portion 422 and the side portion 42d. The protruding portion 422 is provided so as to be magnetically or capacitively connected to the side portion 42c and the side portion 42d. That is, the second electrode 42 is configured as a λ/4 resonator.

The first electrode 41 and the second electrode 42 have the same shape. The first electrode 41 and the second electrode 42 are disposed so as to be rotationally symmetric in the XY plane direction. Specifically, the second electrode 42 is disposed in a state of being rotated by 90 degrees in the XY plane direction with respect to the first electrode 41. The first electrode 41 and the second electrode 42 are arranged so that when viewed from one side, the other side appears to be ground. Using the above-described unit structures 10 makes it possible to configure a radio wave refracting plate for both polarized waves. A configuration example of the reference conductor according to the first

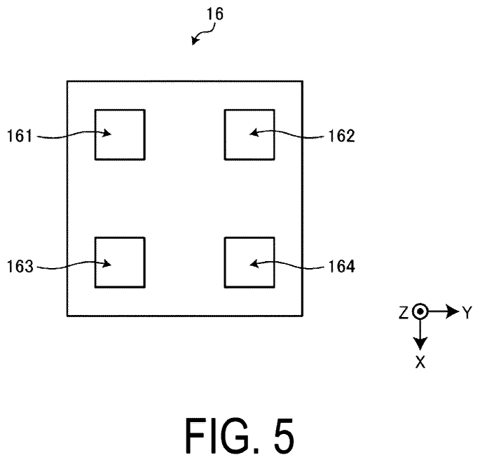

embodiment will be described with reference to FIG. 5. FIG. 5 is a diagram illustrating the configuration example of the reference conductor according to the first embodiment.

The reference conductor 16 is made of a conductor. The reference conductor 16 is formed in a rectangular shape. The reference conductor 16 includes a hole portion 161, a hole portion 162, a hole portion 163, and a hole portion 164.

The hole portions 161 to 164 are provided in order to capacitively or magnetically connect the first resonator 12 and the second resonator 14 to each other. The first resonator 12 and the second resonator 14 are capacitively or magnetically connected to each other via the hole portions 161 to 164.

Each of the first resonator 12 and the second resonator 14 has been illustrated as having a structure in which two λ/4 resonators are overlapped with each other. However, the present disclosure is not limited thereto.

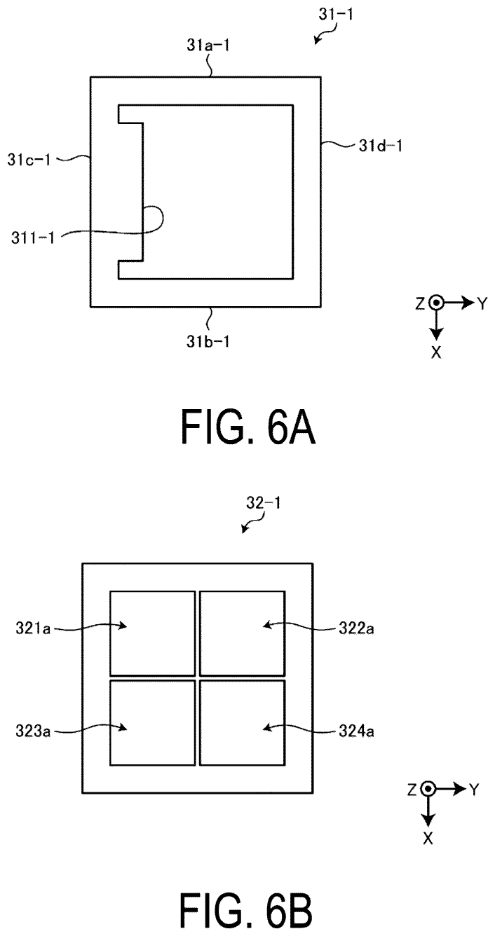

A configuration example of the first resonator according to a variation of the first embodiment will be described with reference to FIGS. 6A and 6B. FIGS. 6A and 6B are diagrams each illustrating a configuration example of the first resonator according to the variation of the first embodiment. Hereinafter, the variation of the first resonator will be described as an example, but the same applies to a variation of the second resonator.

FIG. 6A is a diagram illustrating a configuration example of a first electrode of the first resonator according to the variation of the first embodiment. A first electrode 31-1 is made of a conductor. The first electrode 31-1 is formed in a rectangular frame shape. The first electrode 31-1 includes a protruding portion 311-1. That is, the first electrode 31-1 includes one protruding portion.

The protruding portion 311-1 is provided on a side portion 31c-1 of the first electrode 31-1 parallel to the x-axis. The protruding portion 311-1 is provided so as to protrude to an inner side in the side portion 31c-1. In the first electrode 31-1, no protruding portion is provided on a side portion 31d-1. A clearance is formed between the protruding portion 311-1 and a side portion 31a-1. A clearance is formed between the protruding portion 311-1 and a side portion 31b-1. The protruding portion 311-1 is provided so as to be magnetically or capacitively connected to the side portion 31a-1 and the side portion 31b-1. That is, the first electrode 31-1 is configured as a λ/4 resonator.

FIG. 6B is a diagram illustrating a configuration example of a second electrode of the

first resonator according to the variation of the first embodiment. A second electrode 32-1 is made of a conductor. The second electrode 32-1 is formed in a rectangular shape. The second electrode 32-1 includes a hole portion 321a, a hole portion 322a, a hole portion 323a, and a hole portion 324a. A second electrode 32-1 is formed as a ground conductor. The radio wave received by the first resonator according to the variation of the first embodiment permeates the hole portions 321a to 324a.

The variation of the first resonator has a structure in which the first electrode 31-1 and the second electrode 32-1 overlap each other. For example, the variation of the first resonator may have a structure in which the first electrode 31 illustrated in FIG. 3A and the second electrode 32-1 illustrated in FIG. 6B are overlapped with each other.

### Second Embodiment

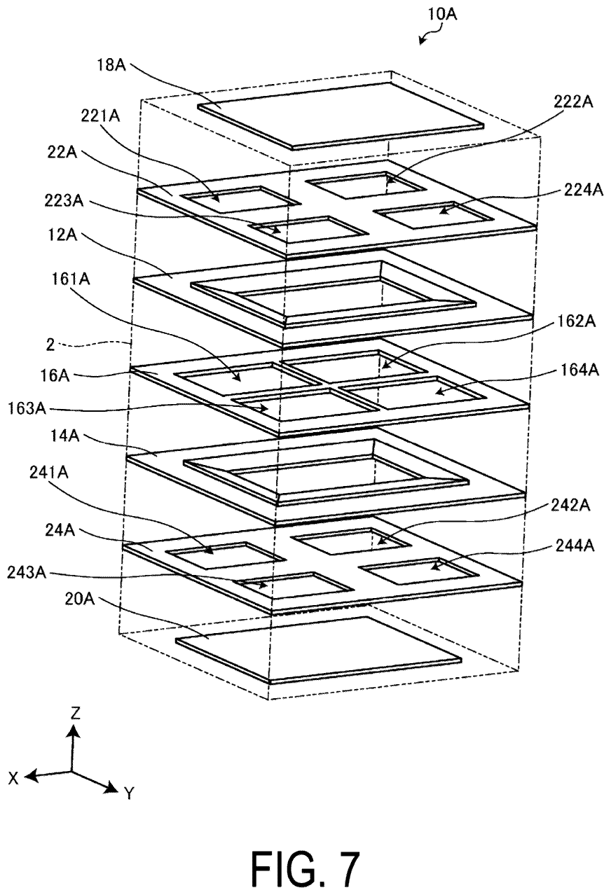

A configuration example of a unit structure according to a second embodiment will be described with reference to FIG. 7. FIG. 7 is a diagram illustrating the configuration example of the unit structure according to the second embodiment.

As illustrated in FIG. 7, a unit structure 10A includes a first resonator 12A, a second resonator 14A, a first reference conductor 16A, a third resonator 18A, a fourth resonator 20A, a second reference conductor 22A, and a third reference conductor 24A.

The first resonator 12A, the second resonator 14A, and the first reference conductor 16A have the same structures as the first resonator 12, the second resonator 14, and the reference conductor 16 illustrated in FIG. 2, respectively, and thus description thereof will be omitted.

The third resonator 18A may be arranged on the substrate 2 to extend on the XY plane. The third resonator 18A is disposed on the uppermost surface of the unit structure 10A. The third resonator 18A includes a conductor. The third resonator 18A is, for example, a patch conductor formed in a rectangular shape. The shape of the third resonator 18A is not limited to the rectangular shape. The shape of the third resonator 18A may be optionally changed according to a design. The third resonator 18A resonates by electromagnetic waves received from the +Z-axis direction. The third resonator 18A may be a λ/2 resonator.

The fourth resonator 20A may be arranged on the substrate 2 to extend on the XY plane. The fourth resonator 20A is disposed on the lowermost surface of the unit structure 10A. The fourth resonator 20A includes a conductor. The fourth resonator 20A is, for example, a patch conductor formed in a rectangular shape. The shape of the fourth resonator 20A is not limited to the rectangular shape. The shape of the fourth resonator 20A may be optionally changed according to a design. The fourth resonator 20A resonates by electromagnetic waves received from the +Z-axis direction. The fourth resonator 20A may be a λ/2 resonator.

The second reference conductor 22A may be arranged between the first resonator 12A and the third resonator 18A in the substrate 2. The second reference conductor 22A may be, for example, at the center between the first resonator 12A and the third resonator 18A in the substrate 2, but the present disclosure is not limited thereto. For example, the second reference conductor 22A may be at a position where the distance from the second reference conductor 22A to the first resonator 12A differs from the distance from the second reference conductor 22A to the third resonator 18A.

The second reference conductor 22A is made of a conductor. The second reference conductor 22A is formed in a rectangular shape. The second reference conductor 22A includes a hole portion 221A, a hole portion 222A, a hole portion 223A, and a hole portion 224A.

The hole portions 221A to 224A are provided in order to capacitively or magnetically connect the first resonator 12A and the third resonator 18A to each other. The first resonator 12A and the third resonator 18A are magnetically or capacitively connected to each other via the hole portions 221A to 224A.

The third reference conductor 24A may be arranged between the second resonator 14A and the fourth resonator 20A in the substrate 2. The second reference conductor 22A may be, for example, at the center between the first resonator 12A and the third resonator 18A in the substrate 2, but the present disclosure is not limited thereto. For example, the second reference conductor 22A may be at a position where the distance from the second reference conductor 22A to the first resonator 12A differs from the distance from the second reference conductor 22A to the third resonator 18A.

The third reference conductor 24A is made of a conductor. The third reference conductor 24A is formed in a rectangular shape. The third reference conductor 24A includes a hole portion 241A, a hole portion 242A, a hole portion 243A, and a hole portion 244A.

The hole portions 241A to 244A are provided in order to capacitively or magnetically connect the second resonator 14A and the fourth resonator 20A to each other. The second resonator 14A and the fourth resonator 20A are magnetically or capacitively connected to each other via the hole portions 241A to 224A.

As illustrated in FIG. 7, the first resonator 12A and the second resonator 14A are disposed symmetrically in the Z-axis direction with respect to the first reference conductor 16A. In the present disclosure, the resonators each including the liquid crystal layer are preferably disposed symmetrically in the Z-axis direction.

The unit structure 10A illustrated in FIG. 7 may have, for example, a configuration in which a resonator including one liquid crystal layer is disposed between the third resonator 18A and the fourth resonator 20A.

As described above, in the second embodiment, the λ/2 resonator is disposed on each of the uppermost surface and the lowermost surface of the unit structure. As a result, the second embodiment can improve a performance of the radio wave refracting plate.

In the second embodiment, the reference conductors each including the liquid crystal layer are disposed symmetrically in the Z-axis direction. As a result, the second embodiment can improve a performance of the radio wave refracting plate.

### Third Embodiment

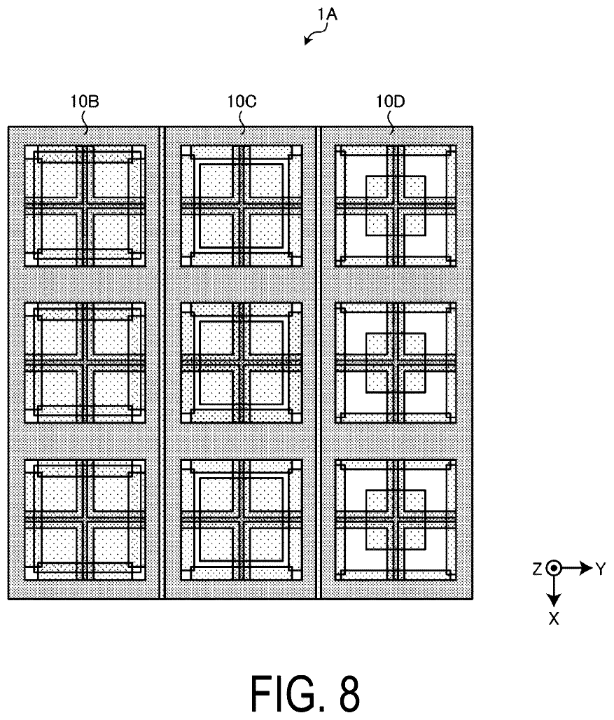

An arrangement example of a unit structure according to a third embodiment will be described with reference to FIG. 8. FIG. 8 is a diagram illustrating the arrangement example of the unit structure according to the third embodiment.

As illustrated in FIG. 8, in the third embodiment, unit structures 10B, unit structures 10C, and unit structures 10D are disposed in a radio wave refracting plate 1A. A liquid crystal layer of the unit structure 10B and a liquid crystal layer of the unit structure 10C are disposed spaced apart from each other. A liquid crystal layer of the unit structure 10C and a liquid crystal of the unit structure 10D are disposed spaced apart from each other. That is, each of voltages of different systems can be applied to a respective one of the unit structure 10B, the unit structure 10C, and the unit structure 10D.

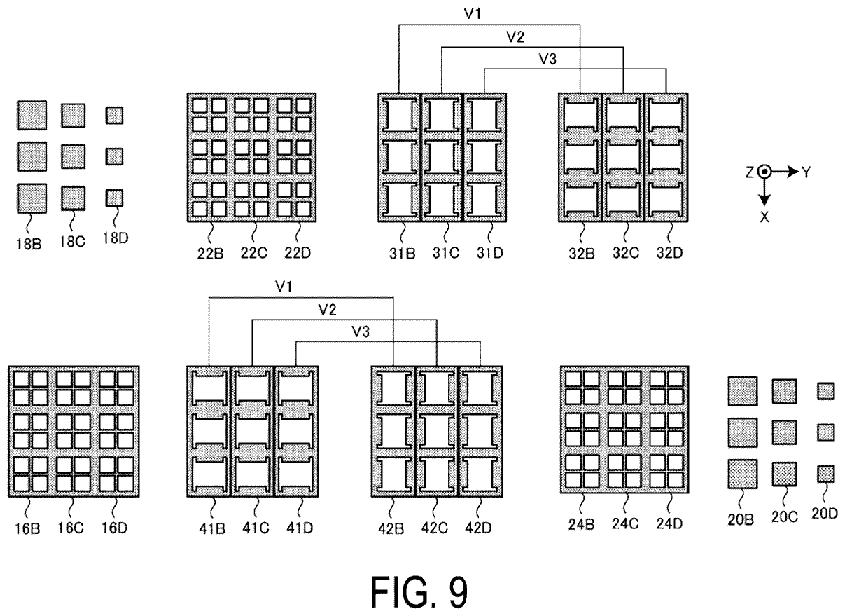

A method of applying a voltage to the unit structure according to the third embodiment will be described with reference to FIG. 9. FIG. 9 is a diagram illustrating the method of applying a voltage to the unit structure according to the third embodiment.

As illustrated in FIG. 9, each of the unit structures 10B includes a first resonator (a first electrode 31B and a second electrode 32B), a second resonator (a first electrode 41B and a second electrode 42B), a first reference conductor 16B, a third resonator 18B, a fourth resonator 20B, a second reference conductor 22B, and a third reference conductor 24B. Each of the unit structures 10C includes a first resonator (a first electrode 31C and a second electrode 32C), a second resonator (a first electrode 41C and a second electrode 42C), a first reference conductor 16C, a third resonator 18C, a fourth resonator 20C, a second reference conductor 22C, and a third reference conductor 24C. Each of the unit structures 10C includes a first resonator (a first electrode 31D and a second electrode 32D), a second resonator (a first electrode 41D and a second electrode 42D), a first reference conductor 16D, a third resonator 18D, a fourth resonator 20D, a second reference conductor 22D, and a third reference conductor 24D. The third resonator 18B, the third resonator 18C, and the third resonator 18D are different in size from each other. Specifically, the third resonator 18B, the third resonator 18C, and the third resonator 18D are larger in size in this order. The fourth resonator 20B, the fourth resonator 20C, and the fourth resonator 20D are different in size from each other. Specifically, the fourth resonator 20B, the fourth resonator 20C, and the fourth resonator 20D are larger in size in this order. The unit structure 10B, the unit structure 10C, and the unit structure 10D have the same structure as the unit structure 10A illustrated in FIG. 7.

A clearance is formed between the first electrode 31B and the first electrode 31C. A clearance is formed between the first electrode 31C and the first electrode 31D. A clearance is formed between the second electrode 32B and the second electrode 32C. A clearance is formed between the second electrode 32C and the second electrode 32D. Thus, each of different voltages of different systems can be applied respectively between the first electrode 31B and the second electrode 32B, between the first electrode 31C and the second electrode 32C, and between the first electrode 31D and the second electrode 32D.

In the example illustrated in FIG. 9, a voltage V1 may be applied between the first electrode 31B and the second electrode 32B. A voltage V2 different from the voltage V1 may be applied between the first electrode 31C and the second electrode 32C. A voltage V3 different from the voltage V1 and the voltage V2 may be applied between the first electrode 31D and the second electrode 32D. That is, each of different voltages can be applied to a respective one of the first resonators each including the liquid crystal layer in the unit structure 10B, the unit structure 10C, and the unit structure 10D. As a result, the unit structure 10B, the unit structure 10C, and the unit structure 10D can have a different change amount in capacitance value.

A clearance is formed between the first electrode 41B and the first electrode 41C. A clearance is formed between the first electrode 31C and the first electrode 31D. A clearance is formed between the second electrode 32B and the second electrode 32C. A clearance is formed between the second electrode 32C and the second electrode 32D. Thus, each of different voltages of different systems can be applied respectively between the first electrode 31B and the second electrode 32B, between the first electrode 31C and the second electrode 32C, and between the first electrode 31D and the second electrode 32D.

In the example illustrated in FIG. 9, a voltage V1 may be applied between the first electrode 41B and the second electrode 42B. A voltage V2 different from the voltage V1 may be applied between the first electrode 41C and the second electrode 42C. A voltage V3 different from the voltage V1 and the voltage V2 may be applied between the first electrode 41D and the second electrode 42D. That is, each of different voltages can be applied to a respective one of the second resonators each including the liquid crystal layer in the unit structure 10B, the unit structure 10C, and the unit structure 10D. As a result, the unit structure 10B, the unit structure 10C, and the unit structure 10D can have a different change amount in capacitance value.

As described above, in the third embodiment, each of different capacitance values can be added to a respective one of the unit structures arrayed adjacent to each other in the radio wave refracting plate. As a result, in the third embodiment, a direction in which the radio wave is refracted can be more flexibly changed.

### Fourth Embodiment

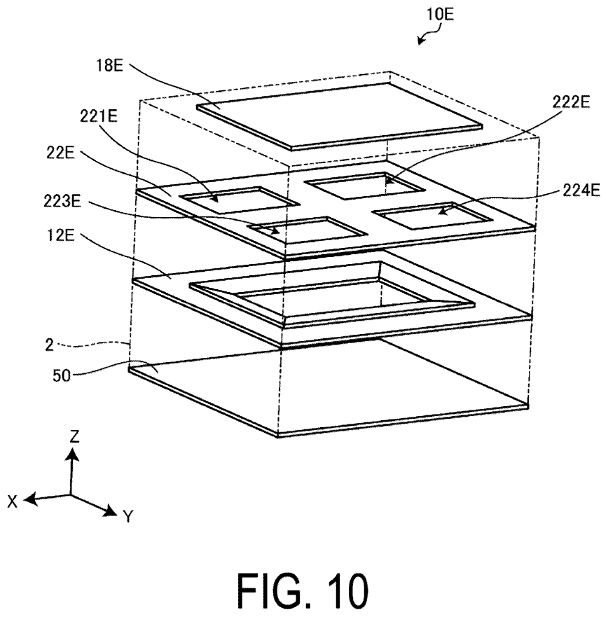

A configuration example of a unit structure according to a fourth embodiment will be described with reference to FIG. 10. FIG. 10 is a diagram illustrating the configuration example of the unit structure according to the fourth embodiment.

As illustrated in FIG. 10, a unit structure 10E includes a first resonator 12E, a third resonator 18E, a second reference conductor 22E, and a reflective conductor 50.

The first resonator 12E, the third resonator 18E, and the second reference conductor 22E have the same configurations as the first resonator 12A, the third resonator 18A, and the second reference conductor 22A illustrated in FIG. 7, respectively, and thus description thereof will be omitted.

The reflective conductor 50 is formed over the entire surface of the XY plane on the substrate 2. The reflective conductor 50 is disposed on the lowermost surface of the unit structure 10E. The reflective conductor 50 includes a conductor. The reflective conductor 50 is configured as a reference conductor (ground conductor). The reflective conductor 50, for example, reflect electromagnetic waves received from the +Z-axis direction to the +Z-axis direction. The reflective conductor 50 is not limited to being formed over the entire surface of the XY plane. The reflective conductor 50 may be, for example, sufficiently large with respect to a wavelength of the received radio wave.

That is, the unit structure 10E includes, in order from the top, the third resonator 18E configured as a λ/2 resonator, the second reference conductor 22E capacitively or magnetically connecting the first resonator 12E and the third resonator 18E to each other, the first resonator 12E including a liquid crystal layer configured as a λ/4 resonator, and the reflective conductor 50 configured as a reference conductor.

In the present embodiment, by two dimensionally disposing a plurality of unit structures 10E, a radio wave reflecting plate that reflects electromagnetic waves incident from the outside can be configured. Configurations corresponding to the first resonator 12E, the third resonator 18E, and the second reference conductor 22E may be disposed symmetrically in the Z-axis direction with respect to the reflective conductor 50. That is, the unit structure 10E may have a configuration in which the first reference conductor 16A of the unit structure 10A is replaced with the reflective conductor 50.

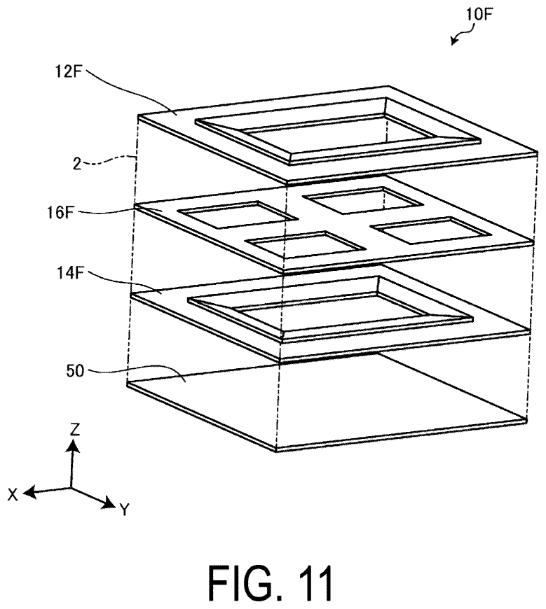

Although the unit structure 10E has been described such that the 22 resonator is disposed on the uppermost surface, the present disclosure is not limited thereto. In the unit structure 10E, a λ/4 resonator including a liquid crystal layer may be disposed instead of the λ/2 resonator. That is, at least one of the two resonators included in the unit structure may be the λ/4 resonator including the liquid crystal layer. FIG. 11 is a diagram illustrating a configuration example of a unit structure according to a variation of the fourth embodiment.

As illustrated in FIG. 11, a unit structure 10F includes a first resonator 12F, a second resonator 14F, a reference conductor 16F, and a reflective conductor 50.

The first resonator 12F, the second resonator 14F, and the reference conductor 16F have the same structures as the first resonator 12, the second resonator 14, and the reference conductor 16 illustrated in FIG. 2, respectively, and thus description thereof will be omitted.

That is, the unit structure 10F includes, in order from the top, the first resonator 12F configured as a λ/4 resonator, the reference conductor 16F capacitively or magnetically connecting the first resonator 12F and the second resonator 14F to each other, the second resonator 14F configured as a λ/4 resonator, and the reflective conductor 50 configured as the reference conductor.

In the present embodiment, also by two dimensionally disposing a plurality of unit structures 10F, a radio wave reflecting plate that reflects electromagnetic waves incident from the outside can be configured.

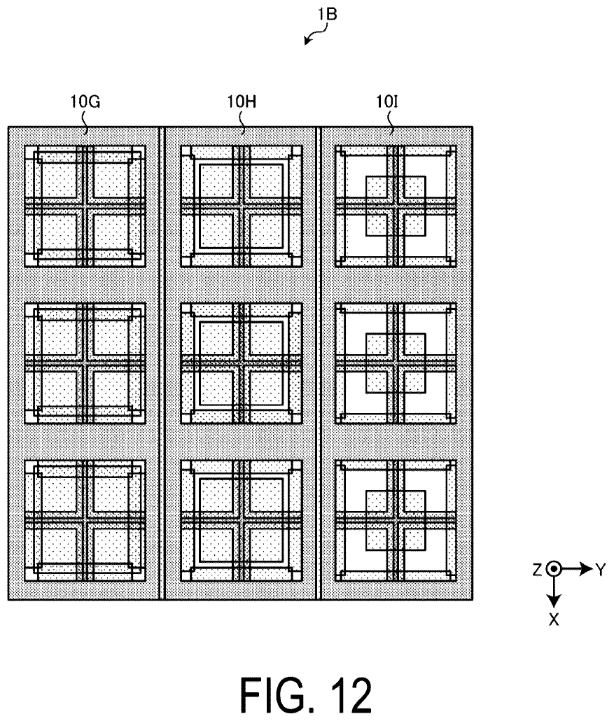

An arrangement example of a unit structure according to a fourth embodiment will be described with reference to FIG. 12. FIG. 12 is a diagram illustrating an arrangement example of the unit structure according to the fourth embodiment.

As illustrated in FIG. 12, a radio wave reflecting plate 1B includes unit structures

10G, unit structures 10H, and unit structures 10I. A liquid crystal layer of the unit structure 10G and a liquid crystal layer of the unit structure 10H are disposed spaced apart from each other. A liquid crystal layer of the unit structure 10H and a liquid crystal layer of the unit structure 10I are disposed spaced apart from each other. That is, voltages of different systems can be applied to the unit structure 10G, the unit structure 10H, and the unit structure 10I, respectively.

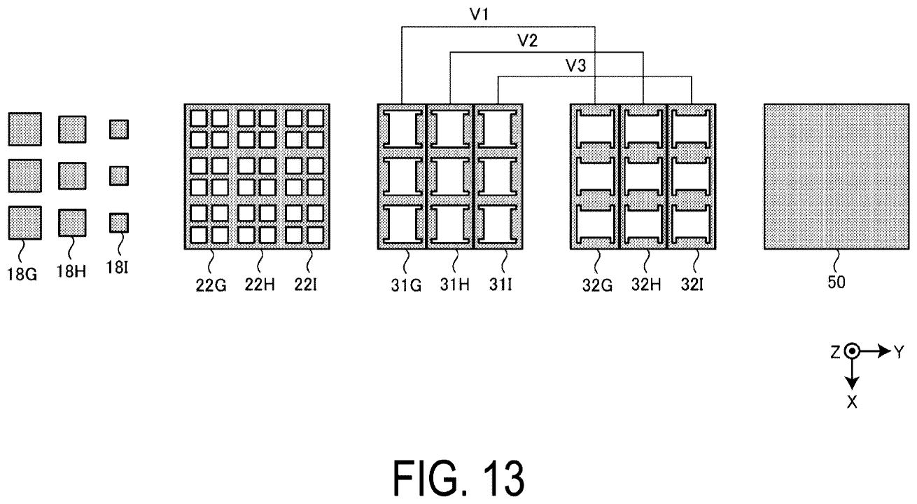

A method of applying a voltage to the unit structure according to the fourth embodiment will be described with reference to FIG. 13. FIG. 13 is a diagram illustrating the method of applying a voltage to the unit structure according to the fourth embodiment. As illustrated in FIG. 13, each of the unit structures 10G includes a first resonator (a

first electrode 31G and a second electrode 32G), a third resonator 18G, a second reference conductor 22G, and a reflective conductor 50. Each of the unit structure 10H includes a first resonator (a first electrode 31H and a second electrode 32H), a third resonator 18H, a second reference conductor 22H, and the reflective conductor 50. Each of the unit structure 10I includes a first resonator (a first electrode 31I and a second electrode 32I), a third resonator 18I, a second reference conductor 221, and the reflective conductor 50. The third resonator 18G, the third resonator 18H, and the third resonator 18I are different in size from each other. Specifically, the third resonator 18G, the third resonator 18H, and the third resonator 18I are larger in size in this order. The unit structure 10G, the unit structure 10H, and the unit structure 10I have a similar structure to the unit structure 10E illustrated in FIG. 10.

A clearance is formed between the first electrode 31G and the first electrode 31H. A clearance is formed between the first electrode 31H and the first electrode 31I. A clearance is formed between the second electrode 32G and the second electrode 32H. A clearance is formed between the second electrode 32H and the second electrode 32I. Thus, each of different voltages of different systems can be applied respectively between the first electrode 31G and the second electrode 32G, between the first electrode 31H and the second electrode 32H, and between the first electrode 31I and the second electrode 32I.

In the example illustrated in FIG. 13, a voltage V1 may be applied between the first electrode 31G and the second electrode 32G. A voltage V2 different from the voltage V1 may be applied between the first electrode 31H and the second electrode 32H. A voltage V3 different from the voltage V1 and the voltage V2 may be applied between the first electrode 31I and the second electrode 32I. That is, each of different voltages can be applied to a respective one of the first resonators each including the liquid crystal layer in the unit structure 10G, the unit structure 10H, and the unit structure 10I. As a result, the unit structure 10G, the unit structure 10H, and the unit structure 10I can have a different change amount in capacitance value.

As described above, in the fourth embodiment, each of different capacitance values can be added to a respective one of the unit structures arrayed adjacent to each other in the radio wave reflecting plate. As a result, in the fourth embodiment, a direction in which the radio wave is reflected can be more flexibly changed.

The embodiments of the present disclosure have been described above, but the present disclosure is not limited by the contents of the embodiment. Constituent elements described above include those that can be easily assumed by a person skilled in the art, those that are substantially identical to the constituent elements, and those within a so-called range of equivalency. The constituent elements described above can be combined as appropriate.

Various omissions, substitutions, or modifications of the constituent elements can be made without departing from the spirit of the above-described embodiment.

### BRIEF DESCRIPTION OF THE DRAWINGS

1, 1A Radio wave refracting plate

2 Substrate

10, 10A, 10B, 10C, 10D, 10E, 10F, 10G, 10H, 10I Unit structure

12 12A 12E 12F First resonator

14, 14A, 14F Second resonator

16 Reference conductor

16A First reference conductor

18A, 18E, 18G, 18H, 18I Third resonator

20A Fourth resonator

22A, 22B, 22C, 22D, 22E, 22G, 22H, 22I Second reference conductor

24A, 24B, 24C, 24D Third reference conductor

31, 31B, 31C, 31D, 31G, 31H, 31I, 31-1, 41, 41B, 41C, 41D First electrode

32, 32B, 32C, 32D, 32G, 32H, 32I, 32-1, 42, 42B, 42C, 42D Second electrode

50 Reflective conductor

1. A radio wave control plate comprising:
a plurality of unit structures arrayed in a first plane direction; and
a reference conductor serving as a reference potential of the plurality of unit structures, wherein
each of the plurality of unit structures comprises
a first resonator extending in the first plane direction, and
a second resonator separated from the first resonator in a first direction and extending in the first plane direction, and
at least one of the first resonator or the second resonator comprises
a first electrode extending in the first plane direction,
a second electrode separated from the first electrode in the first direction and extending in the first plane direction, and
a liquid crystal layer disposed between the first electrode and the second electrode and extending in the first plane direction.

2. The radio wave control plate according to claim 1, wherein
the first electrode is a λ/4 resonator formed in a frame-shape body and comprising a protruding portion protruding to an inner side on an inner periphery of the frame-shape body, and
the second electrode comprises a hole portion.

3. The radio wave control plate according to claim 1, wherein
each of the first electrode and the second electrode is a λ/4 resonator formed in a frame-shape body and comprising a protruding portion protruding to an inner side on an inner periphery of the frame-shape body, and
the first electrode and the second electrode are disposed and shapes thereof are rotationally symmetric in the first plane direction.

4. The radio wave control plate according to claim 3, wherein
the first electrode is disposed in a state in which a shape of the first electrode is rotated by 90 degrees in the first plane direction with respect to the second electrode.

5. The radio wave control plate according to claim 2, wherein
the plurality of unit structures are arrayed spaced apart from each other.

6. The radio wave control plate according to claim 2, wherein
the first electrode, the second electrode, and the liquid crystal layer are disposed symmetrically in the first direction with respect to the reference conductor.

7. The radio wave control plate according to claim 6, wherein
each of the plurality of unit structures comprises
a first λ/2 resonator disposed above the first resonator and extending in the first plane direction, and
a second λ/2 resonator disposed below the second resonator and extending in the first plane direction.

8. The radio wave control plate according to claim 1, wherein
each of the plurality of unit structures comprises a reflective conductor disposed below the second resonator and extending over an entire surface of the second resonator in the first plane direction.

9. The radio wave control plate according to claim 8, wherein
the first electrode is a λ/4 resonator formed in a frame-shape body and comprising a protruding portion protruding to an inner side on an inner periphery of the frame-shape body, and
the second electrode comprises a hole portion.

10. The radio wave control plate according to claim 8, wherein
each of the first electrode and the second electrode is a λ/4 resonator formed in a frame-shape body and comprising a protruding portion protruding to an inner side on an inner periphery of the frame-shape body, and
the first electrode and the second electrode are disposed and shapes thereof are rotationally symmetric in the first plane direction.

11. The radio wave control plate according to claim 10, wherein
the first electrode is disposed in a state in which a shape of the first electrode is rotated by 90 degrees in the first plane direction with respect to the second electrode.

12. The radio wave control plate according to claim 9, wherein
the plurality of unit structures are arrayed spaced apart from each other.

13. The radio wave control plate according to claim 9, wherein
the first electrode is configured as a λ/2 resonator, and
the second electrode is configured as the λ/4 resonator.

14. A composite resonator comprising:
a first resonator extending in a first plane direction; and
a second resonator separated from the first resonator in a first direction and extending in the first plane direction, wherein
at least one of the first resonator or the second resonator comprises
a first electrode extending in the first plane direction,
a second electrode separated from the first electrode in the first direction and extending in the first plane direction, and
a liquid crystal layer disposed between the first electrode and the second electrode and extending in the first plane direction.

15. The composite resonator according to claim 14, further comprising a reflective conductor disposed below the second resonator and extending over an entire surface of the second resonator in the first plane direction.

16. The composite resonator according to claim 14, wherein
the first electrode is a λ/4 resonator formed in a frame-shape body and comprising a protruding portion protruding to an inner side on an inner periphery of the frame-shape body, and
the second electrode comprises a hole portion.

17. The composite resonator according to claim 14, wherein
each of the first electrode and the second electrode is a λ/4 resonator formed in a frame-shape body and comprising a protruding portion protruding to an inner side on an inner periphery of the frame-shape body, and
the first electrode and the second electrode are disposed and shapes thereof are rotationally symmetric in the first plane direction.

18. The composite resonator according to claim 17, wherein
the first electrode is disposed in a state in which a shape of the first electrode is rotated by 90 degrees in the first plane direction with respect to the second electrode.
